(19) United States
(12) Patent Application Publication
(10) Pub. No.: US 2006/0067563 A1
(43) Pub. Date: Mar. 30, 2006

(54) Biometric information management and enrollment system

(76) Inventor: Steven Whitehead, West Des Moines, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 11/220,375

(22) Filed: Sep. 6, 2005

Related U.S. Application Data
(60) Provisional application No. 60/607,237, filed on Sep. 3, 2004.

(51) Int. Cl. G06K 9/00

(52) U.S. Cl. 382/115; 382/124

(57) ABSTRACT

A biometric information management and enrollment system management system is provided. The system comprises a general purpose computer adapted for executing a computer software application; a card reader operatively connected to the computer for the transfer and storage of information to and from the computer; a digital camera operatively connected to the computer for the transfer of digital images to the computer; a fingerprint scanner operatively connected to the computer for the transfers of fingerprint information to the computer; wherein the software application adapted for controlling the computer, card reader digital camera, and fingerprint reader; wherein the software application having a graphical user interface having a task selection area and data display and manipulation area wherein the task selection determines the data display; and wherein the information comprise individual biometric information.

### RELATED APPLICATIONS

This application claims priority and incorporates by reference U.S. Provisional Application No. 60/607,237 filed on Sep. 3, 2004.

### BACKGROUND OF THE INVENTION

The present invention relates to a biometric information management and enrollment system. In particular, to a system comprised of a software application and various apparatus used to track, store, and manipulate information including biometric information and more particularly for use with Native American tribal enrollment functions.

### SUMMARY OF THE INVENTION

An object of the present invention comprises providing an improved biometric information management and enrollment system.

These and other objects of the present invention will become apparent to those skilled in the art upon reference to the following specification, drawings, and claims.

The present invention intends to overcome the difficulties encountered heretofore. To that end, a biometric information management and enrollment system management system is provided. The system comprises a general purpose computer adapted for executing a computer software application; a card reader operatively connected to the computer for the transfer and storage of information to and from the computer; a digital camera operatively connected to the computer for the transfer of digital images to the computer; a fingerprint scanner operatively connected to the computer for the transfers of fingerprint information to the computer; wherein the software application adapted for controlling the computer, card reader digital camera, and fingerprint reader; wherein the software application having a graphical user interface having a task selection area and data display and manipulation area wherein the task selection determines the data display; and wherein the information comprise individual biometric information.

### BRIEF DESCRIPTION OF THE DRAWINGS

FIG. 1 is a screen shot of a graphical user interface of a software application.

FIG. 2 is a screen shot of a new enrollee wizard of the graphical user interface.

FIG. 3 is a screen shot of a tribal affiliation screen of the wizard.

FIG. 4 is a screen shot of a personal information screen of the wizard.

FIG. 5 is a screen shot of a confirmation screen of the wizard.

FIG. 6 is a screen shot of an enrollee information window.

FIG. 7 is a screen shot of an enrollment tab of the enrollee information window.

FIG. 8 is a screen shot of a card issuer screen.

FIG. 9 is a screen shot of a card issuer confirmation screen.

FIG. 10 is a screen shot of a card issuer screen after card processing.

FIG. 11 is a screen shot of a photo album screen.

FIG. 12 is a screen shot of a family browser screen.

FIG. 13 is a screen shot of an export enrollee information screen

FIG. 14 is a screen shot of an export enrollee wizard.

FIG. 15 is a screen shot of data selection screen of the wizard.

FIG. 16 is a screen shot of a data format selection screen of the wizard.

FIG. 17 is a screen shot of a file location screen of the wizard.

FIG. 18 is a screen shot of a finalization screen of the wizard.

FIG. 19 is a screen shot of a DNA import wizard.

FIG. 20 is a screen shot of a selection screen of the wizard.

FIG. 21 is a screen shot of an enrollee voting screen.

FIG. 22 is a screen shot of the graphical user interface after card activation.

FIG. 23 is a screen shot of the graphical user interface showing the ID card options.

FIG. 24 is a screen shot of a voting session screen.

FIG. 25 is a screen shot of a search panel.

FIG. 26 is a screen shot of a search results screen.

FIG. 27 is a screen shot of a physical description tab of the enrollee window.

FIG. 28 is a screen shot of a relationship tab of the enrollee window.

FIG. 29 is a screen shot of a enrollment history tab of the enrollee window.

FIG. 30 is a screen shot of a DNA tab of the enrollee window.

FIG. 31 is a screen shot of an additional information tab of the enrollee window.

FIG. 32 is a screen shot of an enrollment tab of the enrollee window.

FIG. 33 is a screen shot of a AKA/names tab of the enrollee window.

FIG. 34 is a screen shot of an addresses tab of the enrollee window.

FIG. 35 is a screen shot of a tribal affiliation tab of the enrollee window.

FIG. 36 is a screen shot of a card tab of the enrollee window.

FIG. 37 is a screen shot of a voting tab of the enrollee window.

FIG. 38 is a screen shot of an attached document tab of the enrollee window.

FIG. 39 is a screen shot of a logs tab of the enrollee window.

### DETAILED DESCRIPTION OF THE INVENTION

In the Figures, is shown a biometric enrollment and data management system. The system comprises a card reader, a fingerprint scanner, a digital camera, and a software application operating a general purpose computer. The system enables the creation, manipulation, and transfer of biometric and other information from a database to and from personal identification cards, and in particular from encrypted commercially available smartcards. Smartcards are credit card-sized, often made of flexible plastic (polyvinyl chloride or PVC) embedded with a micro-module containing a single silicon integrated circuit chip with memory and microprocessor. Smartcards are highly secure. Information stored on the chip is difficult to duplicate or disrupt, unlike the outside storage used on magnetic stripe cards that can be easily copied. Chip microprocessor and Co-processor supports DES, 3-DES, RSA or ECC standards for encryption, authentication, and digital signature for non-repudiation.

Unlike the memory cards, the smart cards have embedded within them a processor and often a cryptographically enhanced co-processor. The standard smart card microcontroller contains a CPU and blocks of memory including RAM, ROM, and some sort of nonvolatile memory (usually EEPROM).

The biometric and other information stored on the system can be safely encoded onto the smartcards and then carried with the user/enrollee, who can then use the smart card for identity verification and for other purposes related to the use of the system. The system also has the capability of using plain cards (non-smartcards).

Individual biometric information such as digital photograph, fingerprints, and/or DNA sequence information can be stored in the system and on the smartcards. This can prevent anyone from duplicating the information on the cards and thus preserves the integrity of the personal identification characteristics of the system.

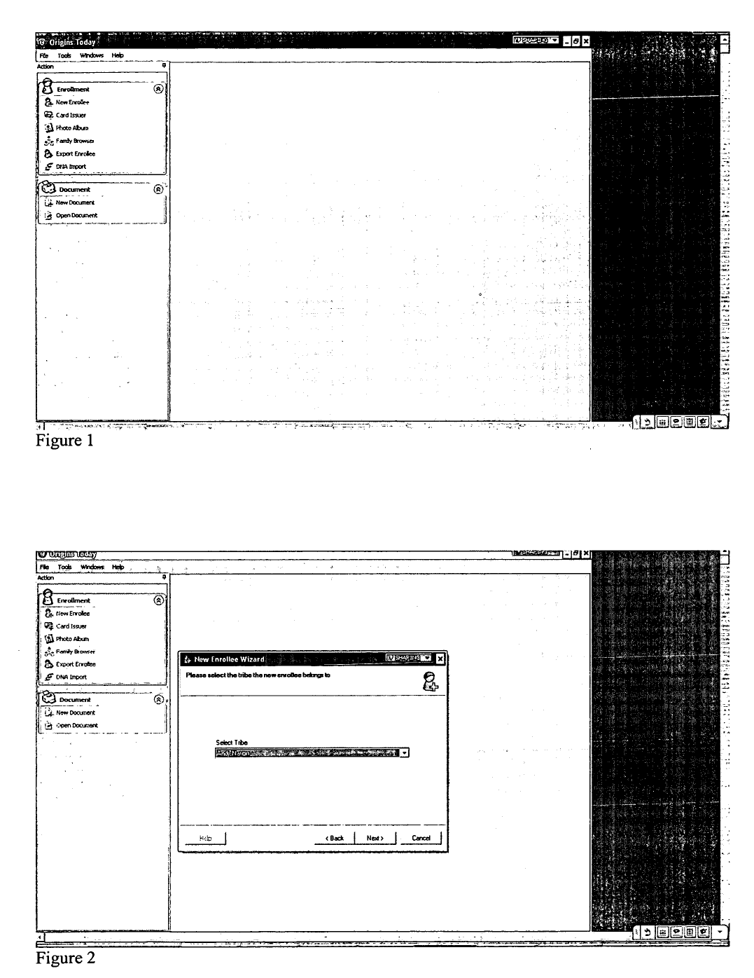

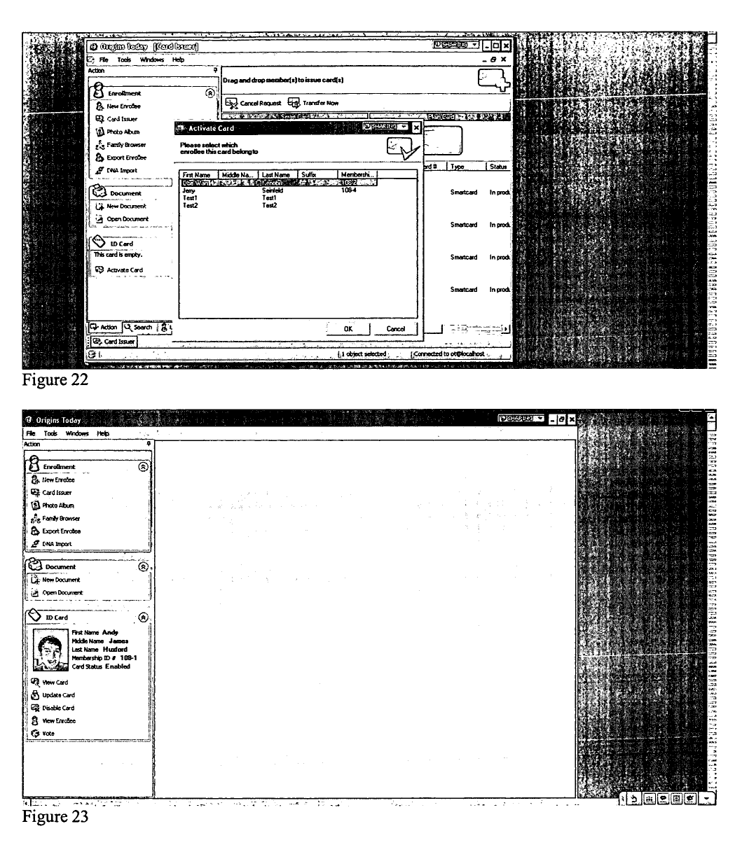

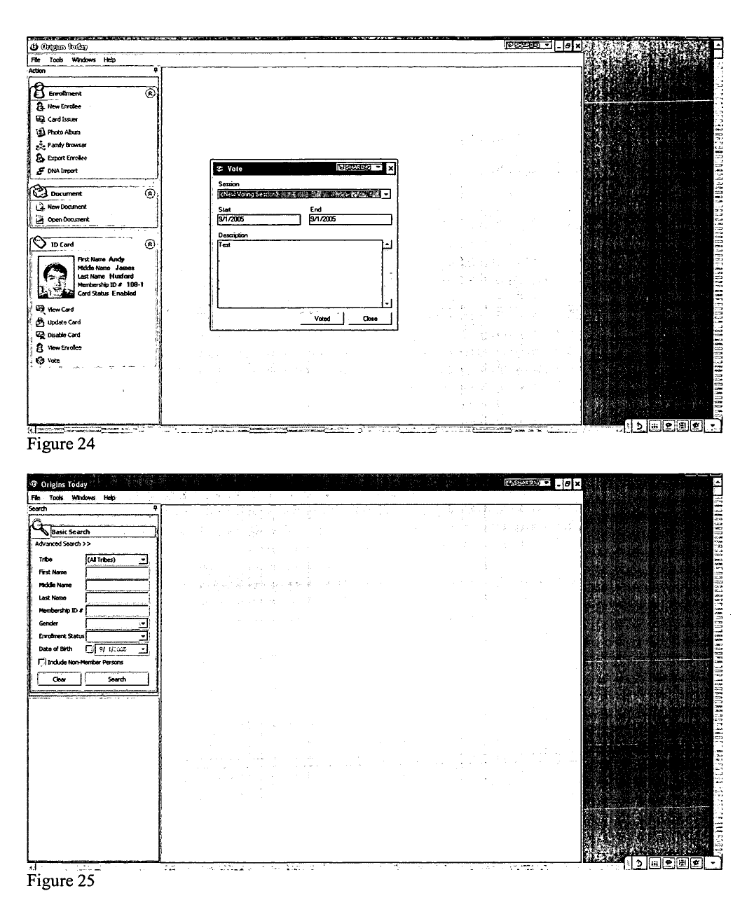

The software application is disclosed and described herein by reference to a plurality of screen shots contained in the Figures. In particular, FIG. 1 shows a basic application screen that shows that the application screen is divided into two main areas. On the left side of the screen is displayed a plurality of panels, each of which contain a series of processing and data manipulation options. The first panel in the series displays several action items, which allow for basic data input, output and manipulation (see FIG. 1). The data operators are grouped under the heading enrollment. A second set of action items are grouped under the heading documents and are used to create reports and data specific documentation. A third set of action items are grouped under the heading ID card (See FIGS. 22 and 24). These items are active when the system is connected to a smartcard reader, and data from a card has been read into the system.

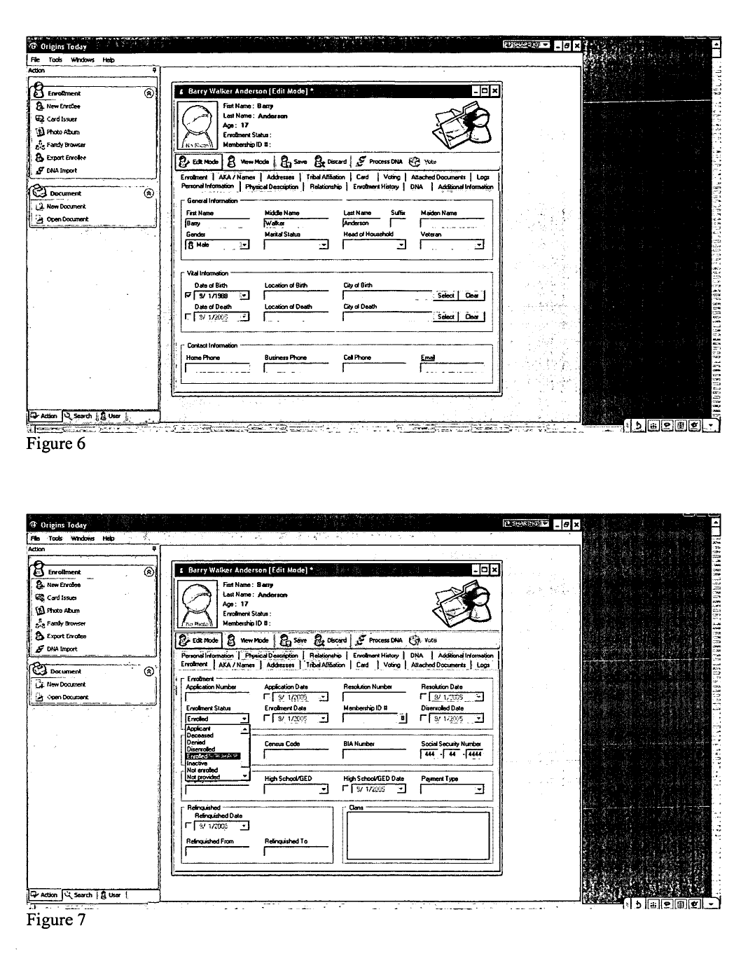

As shown in FIG. 6, the software application utilizes two other panels. In particular, tabs located at the bottom left of the screen allow for selecting between the action, search, and user tabs.

Finally, the second major area of the display screen occupies the remainder of the screen to the right of the panel display section. When items are selected from the various panel items, information related thereto is displayed in this portion of the screen. The software application also includes a series of drop down menus that generally provide a second method of selecting from the various items displayed on the panels.

Returning to FIG. 1 and the enrollment action items, the first item on the list is then ew enrollee item. This allows for the entry of new personal information into the database. The database is generally organized around individuals (or enrollees) belonging or associated with a larger group of persons. For example, in the preferred embodiment of the invention an enrollee is a member or affiliate of a Native American tribe. Those of ordinary skill in the art will appreciate that the invention is not so limited, and that other affiliations are anticipated. Selecting the new enrollee item opens a new enrollee wizard (see FIG. 2). The first screen in the wizard requires selection of the larger group that the enrollee will be identified with. As stated, in the preferred embodiment of the invention the selection will be a Native American tribe. The system can be pre-populated with tribes, which will appear in a drop down menu for selection.

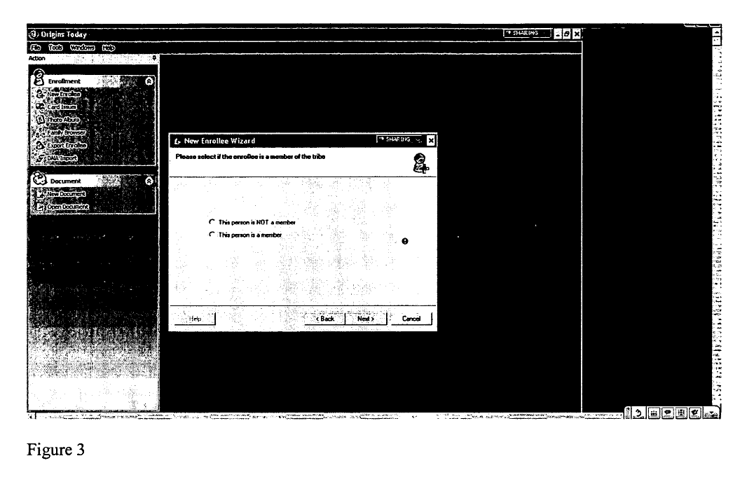

The next screen in the wizard asks if the enrollee is a member or non-member of the tribe selected in the previous screen (see FIG. 3). This allows for entering enrollee information for tribe members, or for tribe employees who are not actual members.

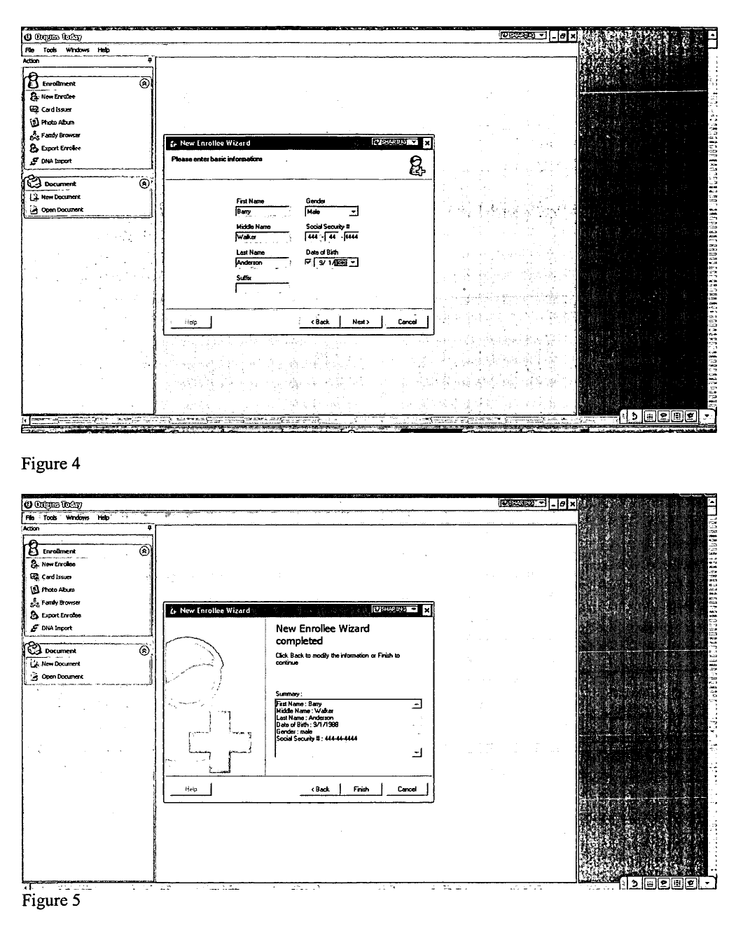

The next screen in the wizard asks for initial personal information for the enrollee, i.e. name, gender, social security number, and date of birth (see FIG. 4). The date of birth field can be disabled by deselecting the check box located thereto (this is a technique that is used through out the application where similar check boxes appear), in which case no date of birth is required.

The final screen in the wizard also for review of the enrollee information and asks for a final confirmation (see FIG. 5). If the information is accepted an enrollee window opens display the just created personal information, and tabs for a plurality of other data fields (see FIG. 6). The enrollee window will be described in detail herein below, however, it should be noted that to before the enrollee window can be saved and closed to allow access to the other portions of the software application, the enrollment status in the enrollment tab of the enrollment window must be entered (see FIG. 7). This is done by selecting from the options in the drop down menu shown in FIG. 7 (the only option not shown in FIG. 7 is the relinquished option).

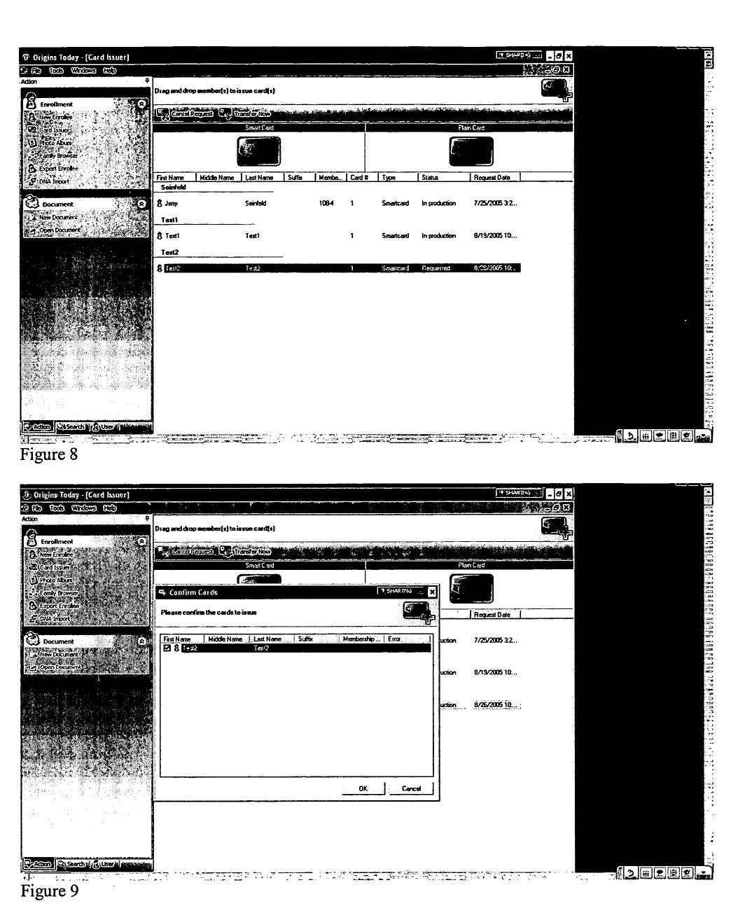

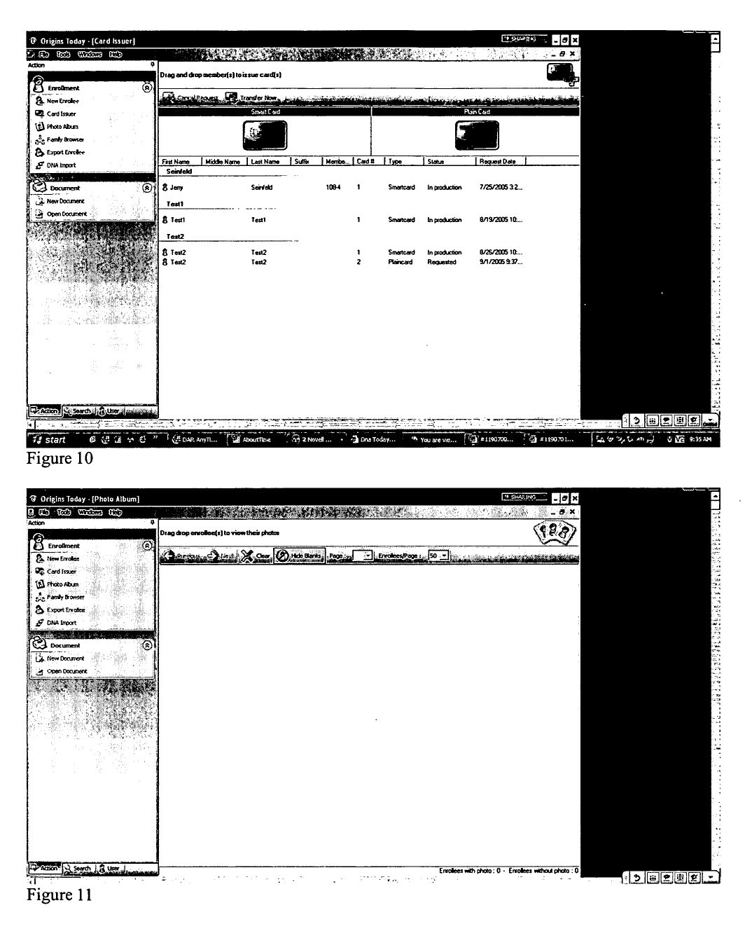

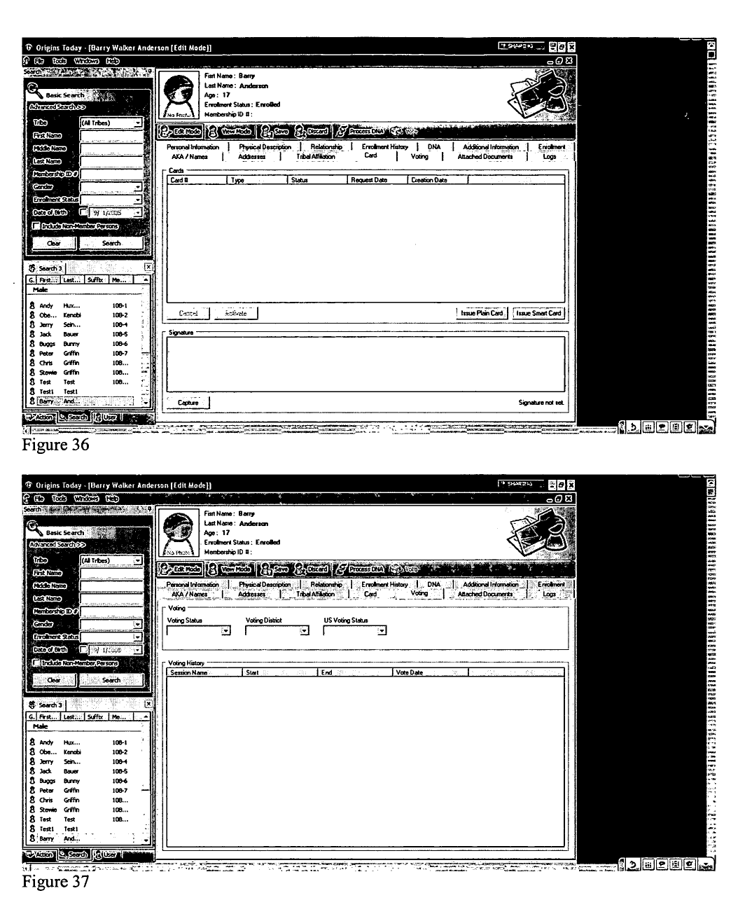

The next item displayed on the action tab panel under the enrollment options is the card issuer item. This item tracks card processing for enrollees (see FIG. 8). Selecting this item will display the screen shown in FIG. 8. The system is designed to utilize two types of cards, namely, the aforementioned smartcards and plain cards. The card issuer screen displays icons for both types of cards, and a list of enrollees in the system and capable of having cards processed. To have an enrollee listed in the card issuer screen, the card tab of the enrollment window for the enrollee must first be initiated (see FIG. 36). This process is described in detail hereinbelow. The card issuer screen will show that the enrollee has requested a card. To initiate processing of the card, the enrollee name can be selected and dragged to the appropriate card icon. To actually create the card the transfer now option is selected. This requires connecting a card reader to the system. The data is transferred to the card. Processing of plain cards is accomplished through integrating the software application with a commercially available ID card software utility provided by EPI SUITE. After clicking and dragging enrollee information to the plain card icon the screen shown in FIG. 9 appears. The system asks for confirmation of instructions to issue the card. After confirming issue, the status changes from “requested” to “in production” (See FIG. 10). For plain cards the processing is by the commercial software, the smartcards can be created in the manner described hereinabove.

The list of enrollees shown on the card issuer screen can be ordered by any of the categories listed on the screen, this is done by selecting a category heading, and then the enrollee list is reordered accordingly.

The next item displayed on the action tab panel under the enrollment options is the photo album item (see FIG. 11). In this screen enrollee photographs are displayed. Enrollees are selected for displayed by clicking and dragging the enrollee from the search tab panel. The search function is described in detail hereinbelow. Several enrollees can be displayed on this screen, and it provides another option to view and select enrollee files for processing or review.

The next item displayed on the action tab panel under the enrollment options is the family browser album item (see FIG. 12). This allows for the viewing related enrollees in either a family tree format, or a hierarchical star format. Again, this is another method of organizing and viewing enrollees. The enrollees are moved to this screen by clicking and dragging them from the search tab.

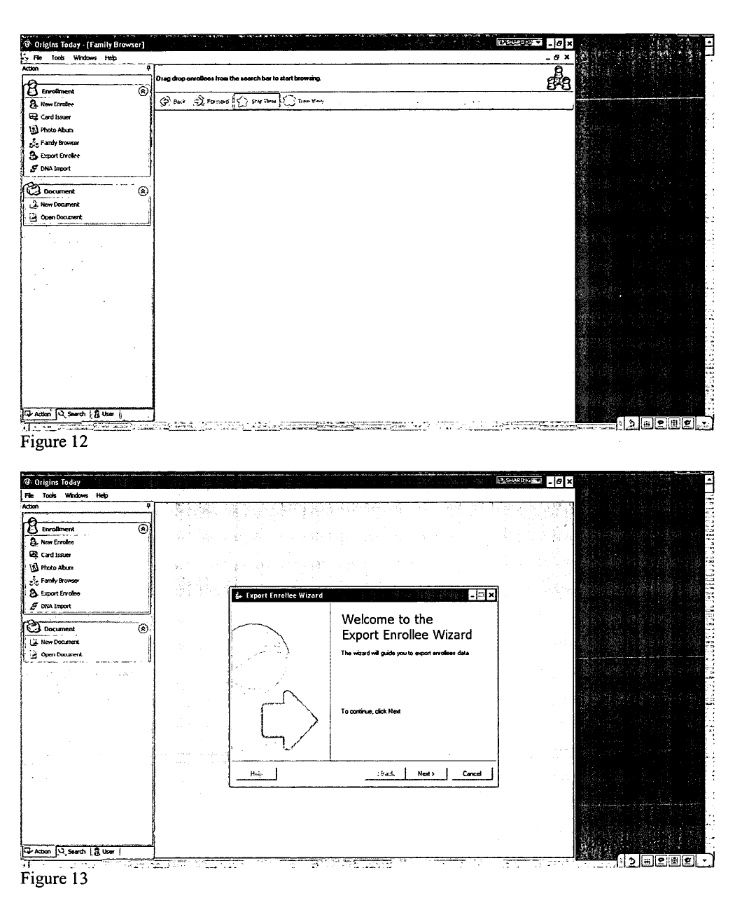

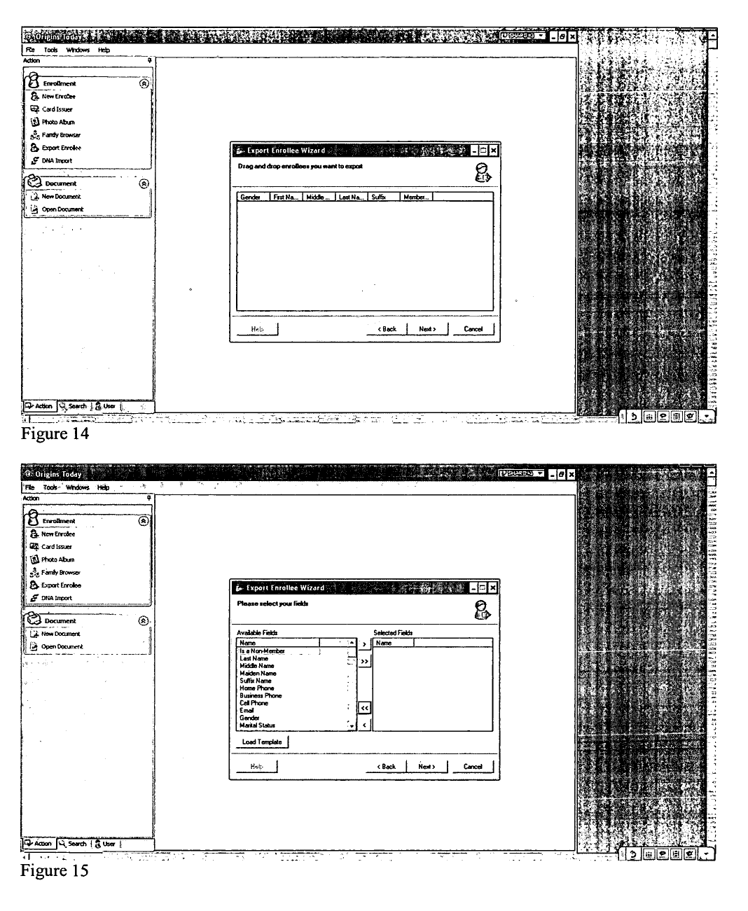

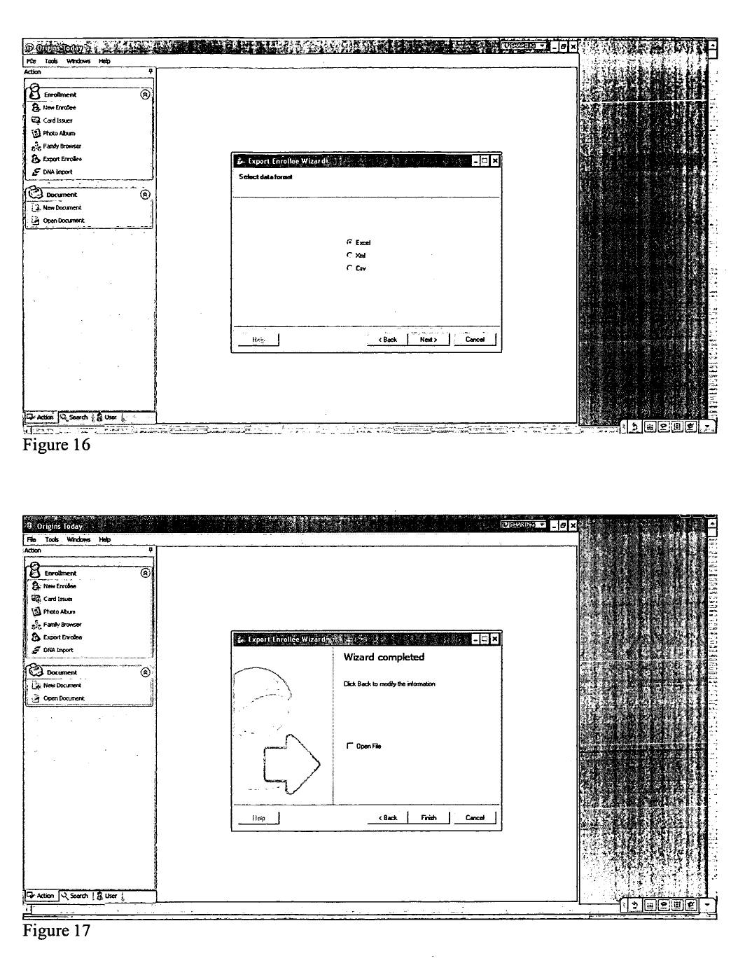

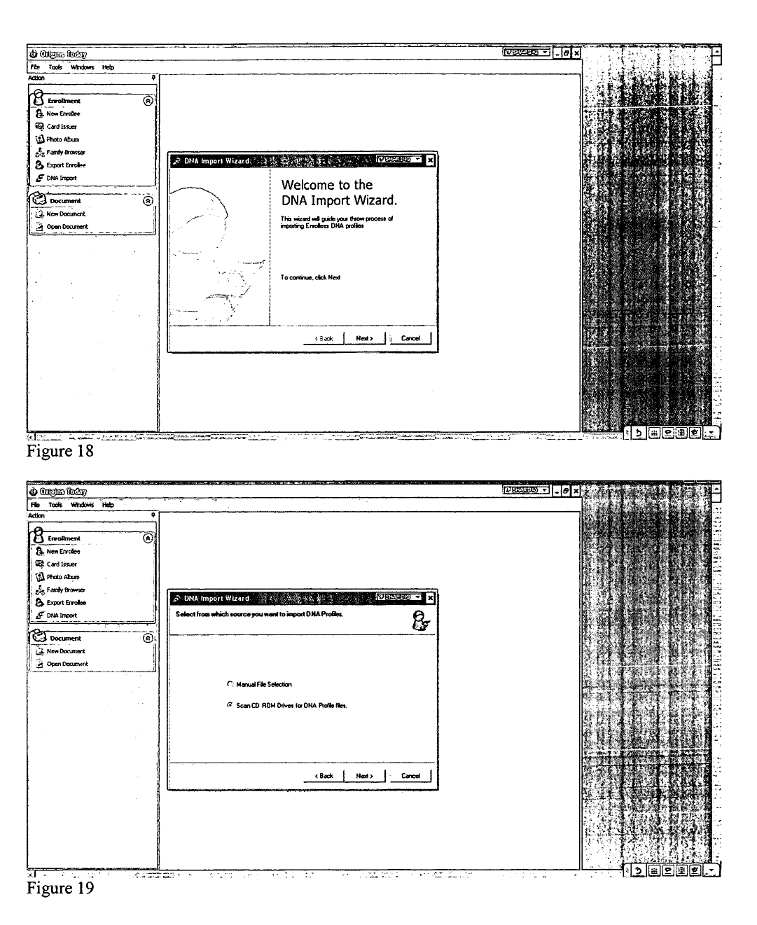

The next item displayed on the action tab panel under the enrollment options is the export enrollee album item (see FIG. 13). Selecting this item initiates an export enrollee wizard. The wizard guides the user through the process of exporting enrollee information. The first screen of the wizard (see FIG. 14) allows for dragging and dropping enrollees whose data is to be exported. The enrollees are selected from the search tab. Next, the data that will be exported are selected (see FIG. 15). The data fields that appear for selection are all the data fields used to create the enrollee records. The next screen in the wizard allows for the selection of the format for the exported data (see FIG. 16). The next screen allows for selection of an output data file and location, including a browse button that allows for selecting a path for the file (see FIG. 17). The wizard ends with a finalization screen that includes an option to open the new data file after the data is exported (see FIG. 18).

Another important aspect of the present invention is the use of biometric information including DNA identification information. This information in associated with enrollees through the DNA import item on the enrollment options of the action tab. This type of information is particularly useful in that it is one of the most reliable personal indicators, and cannot be fraudulently duplicated. Native American tribes can use DNA profiles to verify tribal identity, and then use this information encoded on smartcards to issue identification cards to all tribal members. In the preferred embodiment of the invention, DNA testing would be done by a commercially available testing centers and services and the information imported into the system. The information can be transmitted electronically to the system, or loaded into the system manually from a CD ROM or other similar articles. The system includes a DNA import wizard for this purpose (see FIG. 19).

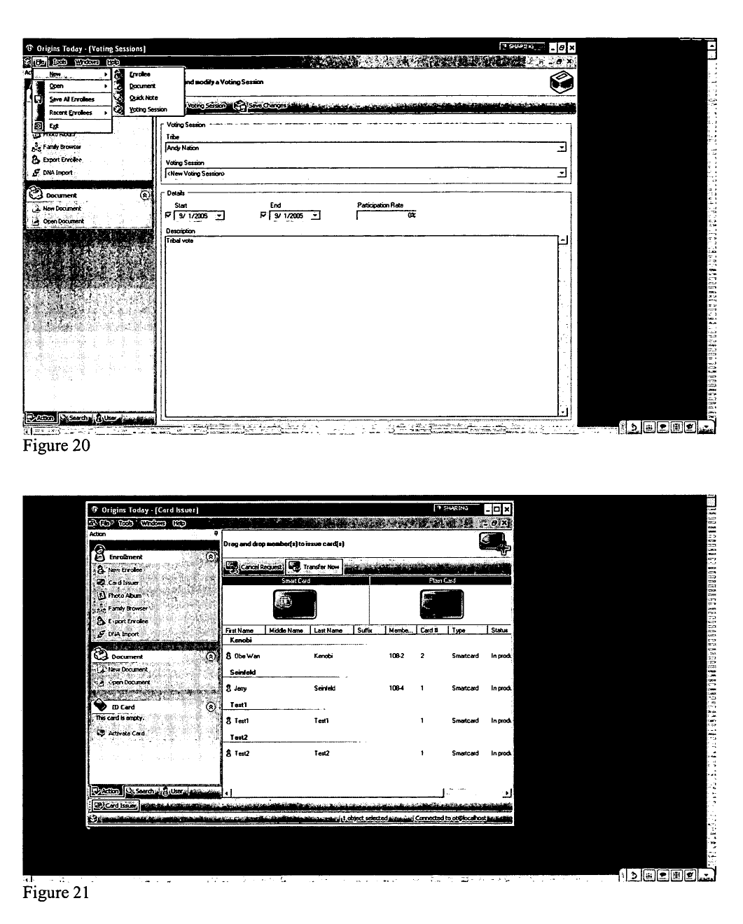

The wizard is initiated by selecting the DNA import item under the enrollment options of the action tab panel. The wizard prompts the user to select between a manual file or CD ROM option (see FIG. 20). If the first option is selected the system then prompts the user to enter the location of the file with the information to be imported. If the second option is selected the system scans the CD ROM drive to find the files with the DNA information. The wizard then terminates with the file information copied into the system and associated with the appropriate enrollees.

Another feature of the present invention comprises the ability to track enrollee voting, and voting sessions (see FIG. 21). The voting session screen is accessed through the file drop down menu, new option. The system allows for the creation of a tribal voting session along with the dates of the vote. The voting activity of enrollees is tracked through the voting tab of the enrollee record, describe in detail herein below.

As mentioned hereinabove, the software application includes on the action tab a set of ID card options. These options become active when a card is placed in card reader connected to the system. The software application first allows for the activation of cards, which allows for reading card information into the system and associating it with an enrollee (see FIG. 21). The activation is done once after a card is created. Selecting the activate card item will display the screen shown in FIG. 22. This allows for selecting the enrollee associated with the card from a list of enrollees. After the card has been activated and read by the system the software application displays the screen shown in FIG. 23. In this screen there a number of items listed below the ID card option. These include view card—which displays the actual enrollee card, update card—which allows for updating the information on the card, disable card—which allows for disabling the card, view enrollee—which opens the enrollee record for the enrollee associated with the card, and the vote item.

FIG. 24 shows the screen displayed after selection of the vote item. Each session that the enrollee has voted in can now be viewed. This allows for verifying whether an enrollee has voted. Voting information can be manually entered into the system when an enrollee votes, and then saved to the enrollee's card. In this manner, enrollees can be prevented from voting more than once.

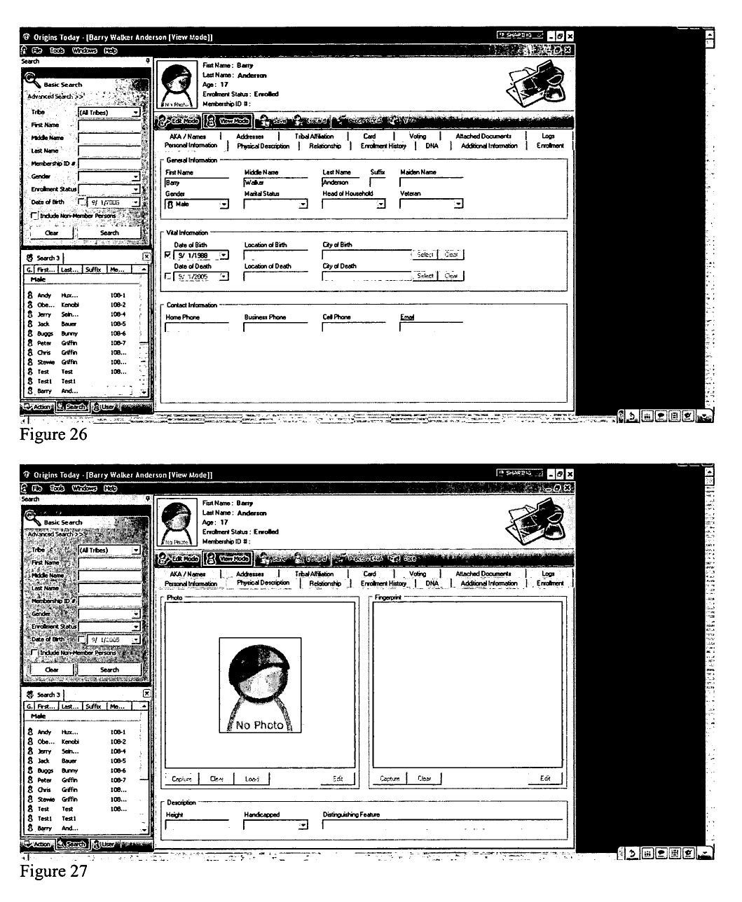

As mentioned hereinabove, the software application includes a search tab panel (see FIG. 25). This allows the user to search for a group or subgroup of enrollees. The search tab displays a number of search fields, including, tribe, name, membership ID, gender, enrollment status, and date of birth. An advanced search option is available, which allows for searching based on most data fields of enrollee records. The results of a search are displayed below the search window as shown in FIG. 26. The enrollees can then be selected from the list for display of enrollee information, or for the various click and drag operations described hereinabove.

FIG. 26 also displays the personal information tab of the enrollee record. The general organization of the enrollee record is in a plurality of tabs that can be used in one of two modes, namely, edit mode, or view mode. The general information tab displays, name, gender, marital status, head of household, veteran status, date of birth, birth location, and the same for death if applicable. Also, the general information tab includes filed for various contact information (phone and email).

FIG. 27 displays the physical description tab. This includes the enrollee's photo graph, fingerprint, and description information (height, handicap, distinguishing feature).

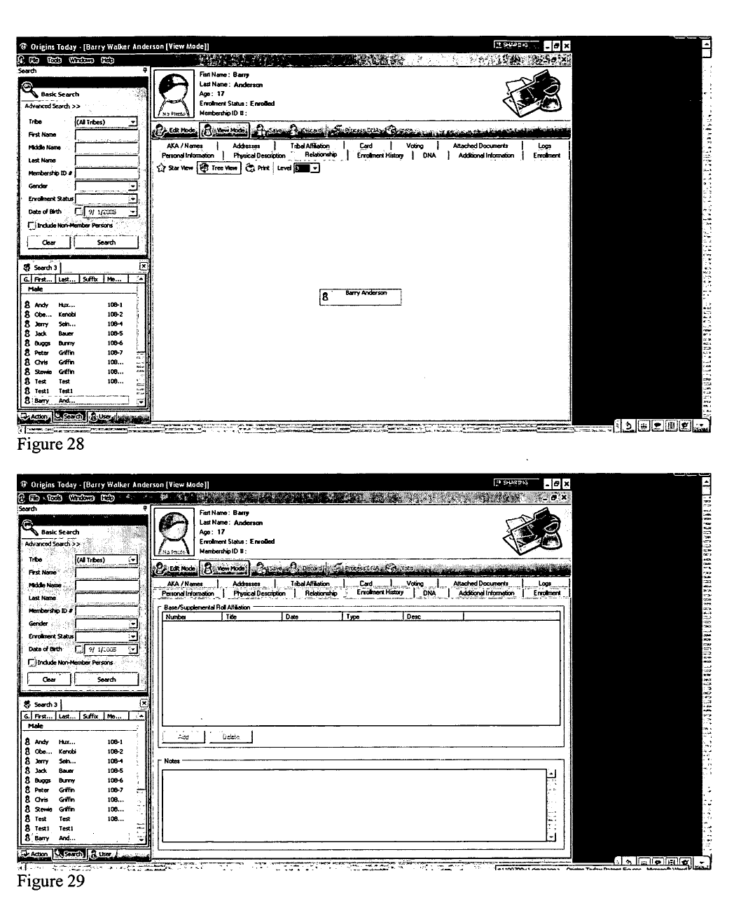

FIG. 28 displays the relationship tab. This information includes the family tree for the enrollee. The family tree is created by selecting the enrollee record and relationship tab for a particular enrollee, and then selecting through the search tab the other members of the family tree. Using the click and drag method, the enrollee's family members are placed in the relationship tab area. The actual relationship is selected by right-clicking and choosing the appropriate family relation from a list of selections (i.e. father, brother, step sister, ect.). The family tree is built in this manner and displayed one of two hierarchical manners, tree or star.

FIG. 29 displays the enrollment history tab. This tab tracks the tribal enrollment events for the enrollee, which can include multiple entries as status changes and is updated over time. The tab also includes a notes field for inclusion of additional information.

FIG. 30 displays the DNA tab. This displays the DNA profile/marker information for the enrollee. This information is imported into the system from the lab tests conducted on the enrollee's DNA sample.

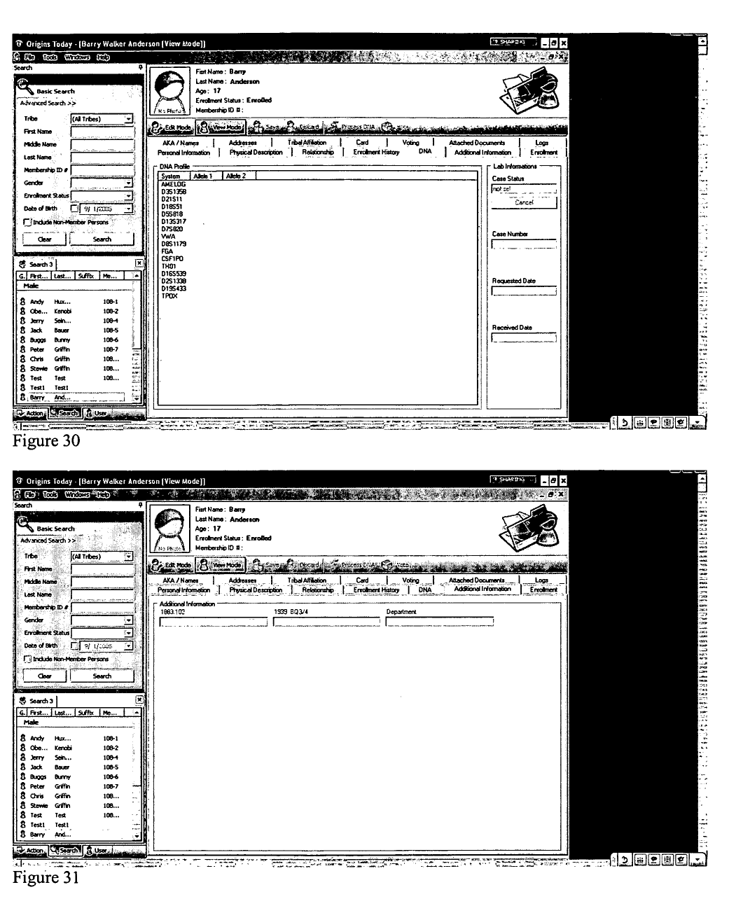

FIG. 31 shows an additional information tab.

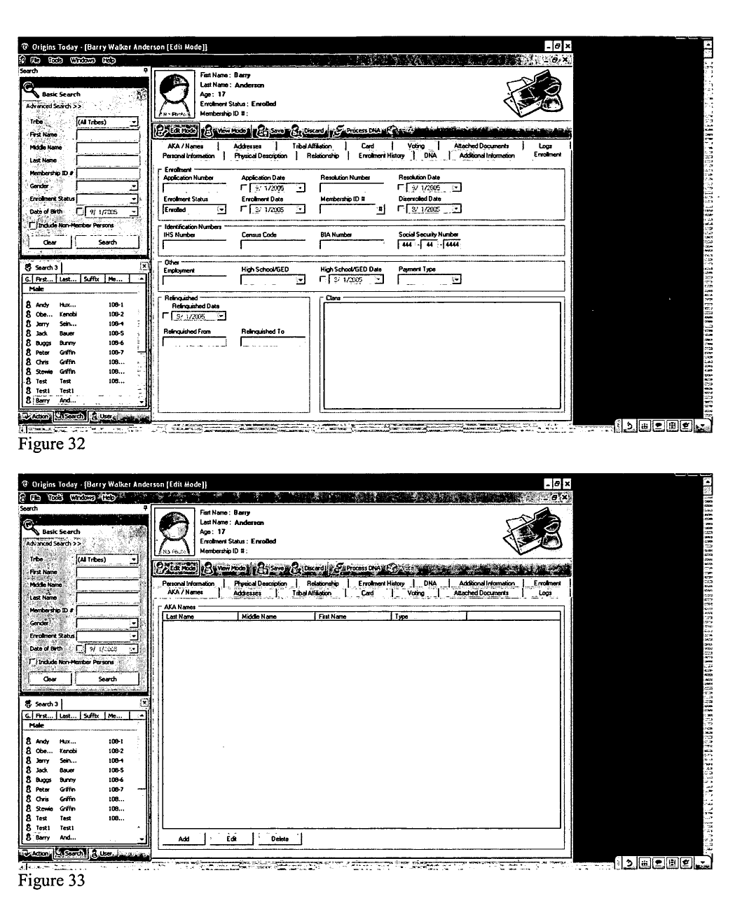

FIG. 32 shows an enrollment tab. This displays tribal enrollment information including information related to enrollment—application date, resolution number (number assigned to resolution of application), and resolution date; enrollment status—status, enrollment date, membership id#, and disenrollment date (if applicable); identification numbers—IHS number (Indian Health Services), census code, BIA number (Bureau of Indian Affairs), and social security number; other—employment status, high school/GED status, high school/GED date, payment type; relinquished—date information. The enrollment tab also displays information about what clans within the tribe the enrollee belongs too.

FIG. 33 shows an AKA/names tab, for displaying alias information.

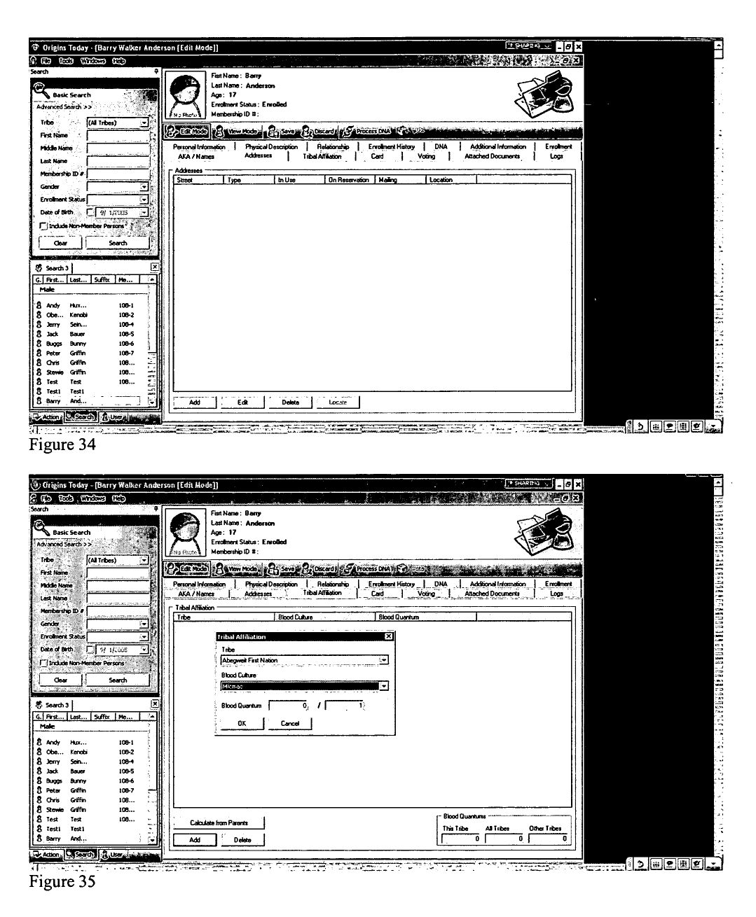

FIG. 34 shows an addresses tab, for displaying enrollee address information.

FIG. 35 shows a tribal affiliation tab. This tab displays various information related to the tribe or tribes that the enrollee belongs too. The information includes information about blood quantum. Blood quanta are used to track tribal ancestor as measured against a point in time of pure ancestry.

FIG. 36 shows a card tab. The card tab tracks the cards (smart or plain) that are issued to an enrollee. The card issuance sequence begins with this screen, by selecting the issue plain or issue smartcard buttons. This tab is also used to capture a signature, through the use of an electronic signature pad.

FIG. 37 shows a voting tab. This screen tracks the voting history of enrollees by tracking voting session log files and the status of the enrollee. Status includes voter tribal and US registration status as well as voting district.

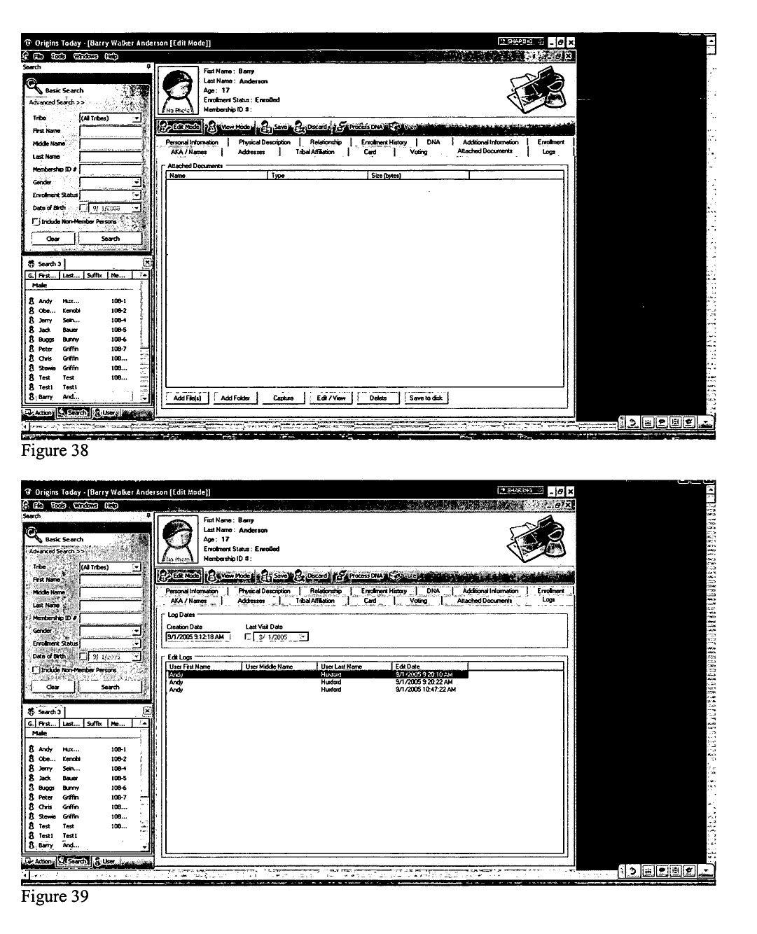

FIG. 38 shows an attached document tab. This screen displays and documents or reports associated with the enrollee, and allows for edit/viewing of the documents.

FIG. 39 shows a logs tab. This screen tracks the records of changes to the enrollee record by listing log files of each event in the system where enrollee information is changed or updated.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A biometric information management and enrollment system management system, comprising;
a general purpose computer adapted for executing a computer software application;
a card reader operatively connected to said computer for the transfer and storage of information to and from said computer;
a digital camera operatively connected to said computer for the transfer of digital images to said computer;
a fingerprint scanner operatively connected to said computer for the transfers of fingerprint information to said computer;
wherein said software application adapted for controlling said computer, card reader digital camera, and fingerprint reader;
wherein said software application having a graphical user interface having a task selection area and data display and manipulation area wherein said task selection determines the data display; and
wherein said information comprise individual biometric information.
